(19) United States
(12) Patent Application Publication
(10) Pub. No.: US 2026/0233458 A1
(43) Pub. Date: Aug. 13, 2026

(54) PLASTICIZING DEVICE, INJECTION MOLDING DEVICE, AND SCREW

(71) Applicant: SEIKO EPSON CORPORATION, Tokyo (JP)

(72) Inventor: Riona TODA, SHIOJIRI-SHI (JP)

(73) Assignee: SEIKO EPSON CORPORATION, Tokyo (JP)

(21) Appl. No.: 19/538,921

(22) Filed: Feb. 12, 2026

(30) Foreign Application Priority Data
Feb. 13, 2025 (JP) 2025-021430

(51) Int. Cl. B29C 64/209; B29C 45/47; B29C 45/60; B29C 64/393; B33Y 30/00

(52) U.S. Cl. CPC B29C 64/209; B29C 45/47; B29C 45/60; B29C 64/393; B33Y 30/00

(57) ABSTRACT

A plasticizing device for plasticizing a material, includes: a drive motor; a screw having a groove forming surface at which a groove is formed; and a barrel facing the groove forming surface and having a communication hole at a position facing a central portion of the groove forming surface, in which the groove has a shape based on an involute curve from the central portion toward a peripheral edge portion of the groove forming surface, the groove is defined by an outer wall, an inner wall having a distance from the central portion in a radial direction shorter than a distance of the outer wall from the central portion, and a bottom surface between the outer wall and the inner wall, the groove includes a first groove portion, and a second groove portion located closer to the central portion than the first groove portion in a direction along the groove.

The present application is based on, and claims priority from JP Application Serial Number 2025-021430, filed Feb. 13, 2025, the disclosure of which is hereby incorporated by reference herein in its entirety.

### BACKGROUND

### 1. Technical Field

The present disclosure relates to a plasticizing device, an injection molding device, and a screw.

### 2. Related Art

JP-A-2021-133521 discloses a plasticizing device including a rotor in which a groove extending in a spiral shape so as to draw an arc from a central portion toward an outer periphery is formed. The groove is formed with a constant width except for a vicinity of a material introduction port provided at a side surface of the rotor.

JP-A-2021-133521 is an example of the related art.

In order to increase a plasticization amount of material, it is effective to widen a groove width of a screw. However, when the groove width is increased without increasing an outer diameter of the screw, it is difficult to secure a thickness of a wall defining the groove. Therefore, there is room for improvement in terms of increasing the plasticization amount while reducing an increase in a size of the screw.

### SUMMARY

According to a first aspect of the present disclosure, a plasticizing device for plasticizing a material is provided. The plasticizing device includes: a drive motor; a screw having a groove forming surface at which a groove is formed, the screw being rotated by the drive motor; and a barrel facing the groove forming surface and having a communication hole at a position facing a central portion of the groove forming surface, in which the groove has a shape based on an involute curve from the central portion toward a peripheral edge portion of the groove forming surface, the groove is defined by an outer wall, an inner wall having a distance from the central portion in a radial direction shorter than a distance of the outer wall from the central portion, and a bottom surface between the outer wall and the inner wall, the groove includes a first groove portion, and a second groove portion located closer to the central portion than the first groove portion in a direction along the groove, an involute coefficient of the second groove portion is smaller than an involute coefficient of the first groove portion, and a groove width of the second groove portion is smaller than a groove width of the first groove portion.

According to a second aspect of the present disclosure, an injection molding device is provided. The injection molding device includes the plasticizing device according to the first aspect, and a mold opening and closing device configured to open and close a mold having a cavity to which the material plasticized by the plasticizing device is to be supplied.

According to a third aspect of the present disclosure, a screw to be mounted on a plasticizing device is provided. The screw includes: a groove forming surface at which a groove is formed, in which the groove has a shape based on an involute curve from a central portion of the groove forming surface toward a peripheral edge portion of the groove forming surface, the groove is defined by an outer wall, an inner wall having a distance from the central portion in a radial direction shorter than a distance of the outer wall from the central portion, and a bottom surface between the outer wall and the inner wall, the groove includes a first groove portion, and a second groove portion located closer to the central portion than the first groove portion in a direction along the groove, an involute coefficient of the second groove portion is smaller than an involute coefficient of the first groove portion, and a groove width of the second groove portion is smaller than a groove width of the first groove portion.

According to a fourth aspect of the present disclosure, a screw to be mounted on a plasticizing device is provided. The screw includes: a groove forming surface at which a spiral groove is formed, in which the groove is defined by an outer wall, an inner wall having a distance from a central portion of the groove forming surface in a radial direction shorter than a distance of the outer wall from the central portion, and a bottom surface between the outer wall and the inner wall, the groove includes a first groove portion, and a second groove portion located closer to the central portion than the first groove portion in a direction along the groove, a thickness in the radial direction of the inner wall defining the first groove portion is different from a thickness in the radial direction of the inner wall defining the second groove portion, and a groove width of the second groove portion is smaller than a groove width of the first groove portion.

### BRIEF DESCRIPTION OF THE DRAWINGS

FIG. 1 shows a schematic configuration of an injection molding device.

FIG. 2 is a cross-sectional view showing a schematic configuration of a plasticizing unit and a mold opening and closing unit.

FIG. 3 is a cross-sectional view showing a schematic configuration of a flat screw and a barrel.

FIG. 4 is a schematic plan view of the barrel.

FIG. 5 is a plan view of a groove forming surface side of the flat screw.

FIG. 6 is a diagram showing an example of a flat screw having a groove having a shape based on an involute curve with a constant involute coefficient.

FIG. 7 is a plan view of a groove forming surface side of a flat screw in a second embodiment.

FIG. 8 is a plan view of a groove forming surface side of a flat screw in a third embodiment.

### DESCRIPTION OF EMBODIMENTS

### A. First Embodiment

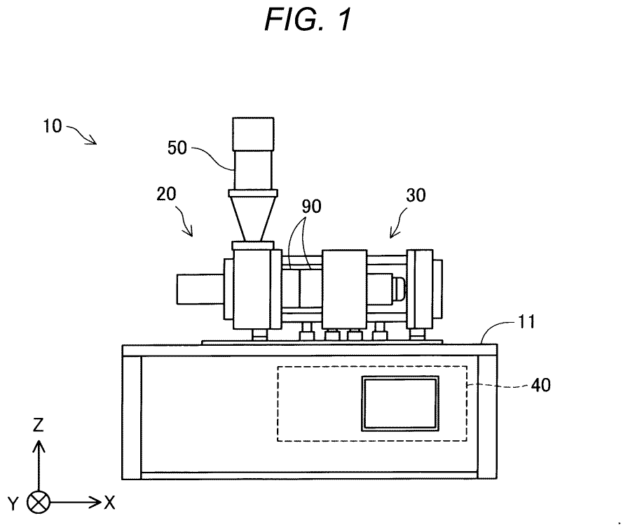

FIG. 1 shows a schematic configuration of an injection molding device 10. FIG. 1 shows arrows indicating X, Y, and Z directions orthogonal to one another. The X direction and the Y direction are parallel to a horizontal plane. The Z direction is parallel to a vertical direction. The X, Y, and Z directions in FIG. 1 and the X, Y, and Z directions in the other drawings indicate the same directions. To specify an orientation, a positive or negative sign is added to the description of the direction, where “+” refers to a positive direction that is a direction indicated by an arrow, and “−” refers to a negative direction that is an opposite direction to the direction indicated by the arrow.

The injection molding device 10 includes a plasticizing unit 20, a mold opening and closing unit 30, and a control unit 40. The injection molding device 10 performs injection molding of a molded product using a mold 90 attached to the mold opening and closing unit 30. In the embodiment, the mold 90 made of metal is attached to the mold opening and closing unit 30. The mold 90 attached to the mold opening and closing unit 30 is not limited to being made of metal, and may also be made of resin or ceramic. The mold 90 made of metal is referred to as a metal mold. The plasticizing unit 20 and the mold opening and closing unit 30 are fixed onto a base 11. The control unit 40 is accommodated in the base 11.

The control unit 40 controls the plasticizing unit 20 and the mold opening and closing unit 30. The control unit 40 is implemented with a computer having one or more processors, a memory, and an input-output interface that inputs and outputs signals from and to the outside. The control unit 40 achieves various functions such as a function of executing processing of molding a molded product by the processor executing a program or commands loaded onto a main storage device. The control unit 40 may be implemented by a configuration in which a plurality of circuits for implementing at least a part of the function are combined, instead of being implemented with the computer.

A hopper 50 into which a material for a molded product is put is coupled to the plasticizing unit 20. An example of the material for the molded product includes a thermoplastic resin formed in a pellet shape. Examples of the thermoplastic resin include acrylonitrile butadiene styrene (ABS), polycarbonate (PC), polyacetal (POM), polypropylene (PP), and polybutylene terephthalate (PBT). The material for the molded product may contain metal or ceramic in addition to the thermoplastic resin. Supply of the material to the plasticizing unit 20 is not limited to the supply from the hopper 50 but may be performed, for example, via a tube through which the material is pressure-fed.

The plasticizing unit 20 plasticizes at least a part of the material supplied from the hopper 50, generates a plasticized material, and injects the generated plasticized material into the mold 90. In the present specification, “plasticizing” has a concept including melting and refers to changing from a solid state to a state having fluidity. Specifically, in a case of a material in which glass transition occurs, plasticizing refers to setting a temperature of the material to a glass transition point or higher. When glass transition does not occur in a material, plasticizing means setting the temperature of the material to a value equal to or higher than a melting point. In the present specification, the plasticizing unit 20 is also referred to as a plasticizing device.

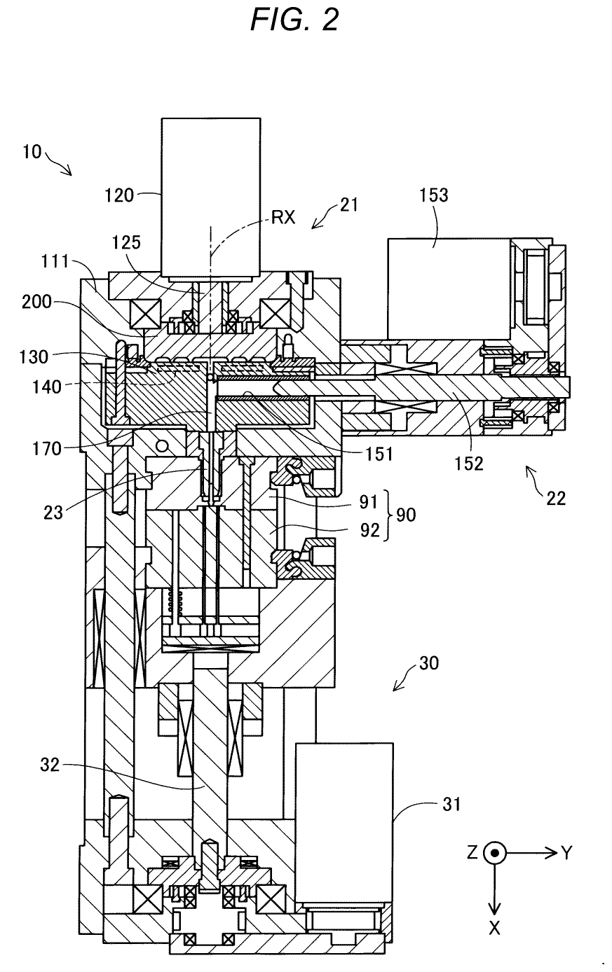

FIG. 2 is a cross-sectional view showing a schematic configuration of the plasticizing unit 20 and the mold opening and closing unit 30. The plasticizing unit 20 includes a plasticizing section 21, a suction feeding section 22, and a nozzle 23.

The plasticizing section 21 plasticizes at least a part of the material supplied from the hopper 50 and generates the plasticized material. The plasticizing section 21 includes a flat screw 200, a drive motor 120, a barrel 130, and a barrel heater 140.

The flat screw 200 is accommodated in a screw case 111. The flat screw 200 is rotated in the screw case 111 around a drive shaft 125 of the drive motor 120 by the drive motor 120. The drive motor 120 is, for example, a servo motor. A central axis RX serving as a rotation center of the flat screw 200 coincides with a center of the drive shaft 125 of the drive motor 120 in a YZ plane. In the embodiment, axial directions of the drive shaft 125 and the central axis RX are along the X direction. Rotation of the flat screw 200 by the drive motor 120 is controlled by the control unit 40. The flat screw 200 may be driven by the drive motor 120 via a decelerator. The flat screw 200 is also referred to as a rotor or simply a screw.

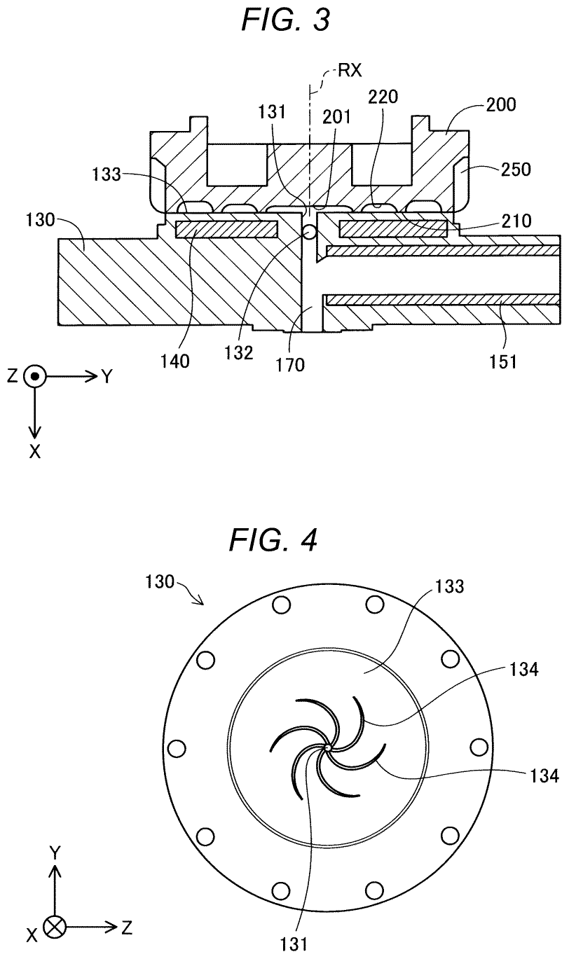

FIG. 3 is a cross-sectional view showing a schematic configuration of the flat screw 200 and the barrel 130. The flat screw 200 has a substantially cylindrical shape in which a length in a direction along the central axis RX is smaller than a length in a direction perpendicular to the central axis RX. The flat screw 200 has a groove forming surface 210 in which spiral grooves 220 are formed around a central portion 201, and an opening 250 provided at an outer peripheral surface of the flat screw 200. The opening 250 communicates with the groove 220 of the groove forming surface 210. In the embodiment, the groove forming surface 210 is provided at a surface of the flat screw 200 at a +X direction side. The material supplied from the hopper 50 is supplied to the groove 220 through the opening 250. A detailed structure of the groove forming surface 210 will be described later.

FIG. 4 is a schematic plan view showing the barrel 130. As shown in FIGS. 3 and 4, the barrel 130 has a facing surface 133 facing the groove forming surface 210 of the flat screw 200. In the embodiment, the facing surface 133 is provided at a surface of the barrel 130 at a −X direction side. In the facing surface 133, a communication hole 131 penetrating the barrel 130 in the X direction is formed at a position facing the central portion 201 of the groove forming surface 210 of the flat screw 200. In the embodiment, the communication hole 131 is formed at a center of the facing surface 133. The communication hole 131 constitutes a part of a flow path 170 through which the plasticized material flows. The facing surface 133 is formed with a plurality of guide grooves 134 that are coupled to the communication hole 131 and extend in a spiral shape from the communication hole 131 toward an outer periphery. To the communication hole 131, an injection cylinder 151 is coupled, which will be described later. The communication hole 131 is provided with a check valve 132 upstream of the injection cylinder 151. The guide grooves 134 may not be provided in the barrel 130. The guide grooves 134 may not be coupled to the communication hole 131.

The barrel heater 140 is embedded in the barrel 130. The barrel heater 140 heats the material supplied to the grooves 220 of the flat screw 200. A temperature of the barrel heater 140 is controlled by the control unit 40.

The material supplied to the grooves 220 of the flat screw 200 is plasticized between the flat screw 200 and the barrel 130 by rotation of the flat screw 200 and heating by the barrel heater 140, flows along the grooves 220 and the guide grooves 134 by rotation of the flat screw 200, and is guided to the central portion 201 of the flat screw 200. The material flowing into the central portion 201 flows out to the suction feeding section 22 from the communication hole 131 formed at a center of the barrel 130.

As shown in FIG. 2, the suction feeding section 22 includes the injection cylinder 151, a plunger 152, and a plunger drive unit 153. The suction feeding section 22 controls an injection amount, injection speed, and injection pressure of the plasticized material from the nozzle 23 under control of the control unit 40. The injection cylinder 151 is a substantially cylindrical member coupled to the communication hole 131 of the barrel 130 and is provided with the plunger 152 therein. The plunger 152 slides inside the injection cylinder 151, and pressure-feeds the plasticized material in the injection cylinder 151 to the nozzle 23. The plunger 152 is driven by the plunger drive unit 153 implemented by a motor.

The flow path 170 is formed in the nozzle 23. When the plunger 152 pressure-feeds the plasticized material in the injection cylinder 151 to the nozzle 23, the plasticized material is supplied from the nozzle 23 to a cavity of the mold 90. The nozzle 23 may be implemented as an open gate type nozzle or may be implemented as a valve gate type nozzle.

The mold 90 includes a fixed mold 91 and a movable mold 92. The fixed mold 91 is a mold at a fixed position in a mold clamping operation. The movable mold 92 is a mold that is moved relative to the fixed mold 91 in the mold clamping operation. The movable mold 92 is attached to the mold opening and closing unit 30 so as to face the fixed mold 91, and is moved in a direction along a mold clamping direction relative to the fixed mold 91 by the mold opening and closing unit 30. In the embodiment, the mold clamping direction is the −X direction.

The mold opening and closing unit 30 includes a mold drive unit 31 and a ball screw 32. The mold drive unit 31 is implemented by a motor, a gear, and the like, and is coupled to the movable mold 92 via the ball screw 32. Drive by the mold drive unit 31 is controlled by the control unit 40. The ball screw 32 transmits power generated by drive of the mold drive unit 31 to the movable mold 92. The mold opening and closing unit 30 opens and closes the mold 90 by moving the movable mold 92 by the mold drive unit 31 and the ball screw 32 under the control of the control unit 40. When the mold 90 is clamped and the fixed mold 91 and the movable mold 92 are brought into contact, the cavity that defines a shape of the molded product is formed between the fixed mold 91 and the movable mold 92. In the present specification, the mold opening and closing unit 30 is also referred to as a mold opening and closing device.

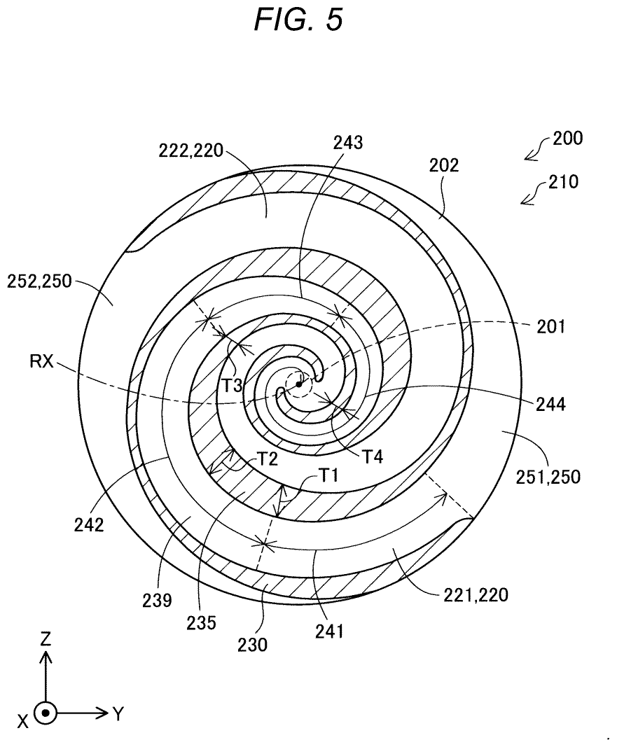

FIG. 5 is a plan view of the flat screw 200 at a groove forming surface 210 side. A shape of the groove forming surface 210 when viewed from a direction along the central axis RX is a circular shape centered on the central axis RX. A first groove 221 and a second groove 222, which are the grooves 220, are formed at the groove forming surface 210. Shapes of the first groove 221 and the second groove 222 are shapes based on an involute curve from the central portion 201 of the groove forming surface 210 toward a peripheral edge portion 202 of the groove forming surface 210. A start point of the involute curve described above is a point on the central axis RX. The first groove 221 and the second groove 222 have the same shape and are rotationally symmetric about the central axis RX.

The groove forming surface 210 has a first wall 230 and a second wall 235. The first wall 230 and the second wall 235 are portions of the groove forming surface 210 protruding toward the facing surface 133 of the barrel 130. The first wall 230 and the second wall 235 constitute side walls of the first groove 221 and the second groove 222. Shapes of the first wall 230 and the second wall 235 are spiral shapes around the central portion 201. The first wall 230 and the second wall 235 have the same shape and are rotationally symmetric about the central axis RX. In FIG. 5, the first wall 230 and the second wall 235 are hatched to clearly show positions of the first wall 230 and the second wall 235.

The groove 220 is defined by an outer wall, an inner wall, and a bottom surface 239 between the outer wall and the inner wall. Here, the inner wall is a wall whose distance from the central portion 201 in a radial direction is shorter than that of the outer wall. In the embodiment, the radial direction is a direction orthogonal to the central axis RX and away from the central axis RX. The first groove 221 is defined with the first wall 230 as the outer wall and the second wall 235 as the inner wall. The second groove 222 is defined with the second wall 235 as the outer wall and the first wall 230 as the inner wall.

The flat screw 200 has a first opening 251 and a second opening 252 which are the openings 250. The first opening 251 and the second opening 252 have the same shape and are rotationally symmetric about the central axis RX. The first groove 221 communicates with the first opening 251. The second groove 222 communicates with the second opening 252.

The first groove 221 includes a first groove portion 241, a second groove portion 242, a third groove portion 243, and a fourth groove portion 244. The first groove portion 241 communicates with the opening 250. The second groove portion 242 communicates with the first groove portion 241 and is located closer to the central portion 201 than the first groove portion 241 in the direction along the first groove 221. The third groove portion 243 communicates with the second groove portion 242 and is located closer to the central portion 201 than the second groove portion 242 in the direction along the first groove 221. The fourth groove portion 244 communicates with the third groove portion 243 and is located closer to the central portion 201 than the third groove portion 243 in the direction along the first groove 221. In FIG. 5, a range of each groove portion is indicated by an arrow. In the present specification, a direction along the groove 220 and from the opening 250 toward the central portion 201 of the groove forming surface 210 is also referred to as a flow path direction. In the flow path direction, an opening 250 side is also referred to as upstream, and a central portion 201 side is also referred to as downstream. That is, the first groove portion 241 is located downstream of the opening 250, the second groove portion 242 is located downstream of the first groove portion 241, the third groove portion 243 is located downstream of the second groove portion 242, and the fourth groove portion 244 is located downstream of the third groove portion 243. The material supplied to the first opening 251 flows along the first groove 221 while being plasticized by the rotation of the flat screw 200 and the heating of the barrel heater 140, and flows into the central portion 201.

An involute coefficient of the involute curve defining the shape of the first groove 221 changes in the direction along the first groove 221. Here, the involute coefficient is a value of a in the following formulas (1) and (2) defining the involute curve.

$$x = a ( cos θ + θ sin θ ) \qquad ( 1 )$$

$$y = a ( sin θ - θ cos θ ) \qquad ( 2 )$$

An involute coefficient of the second groove portion 242 is smaller than an involute coefficient of the first groove portion 241. An involute coefficient of the third groove portion 243 is larger than the involute coefficient of the second groove portion 242. An involute coefficient of the fourth groove portion 244 is smaller than the involute coefficient of the third groove portion 243. In the example shown in FIG. 5, the involute coefficient of the second groove portion 242 is about 0.63 times the involute coefficient of the first groove portion 241. The involute coefficient of the third groove portion 243 is about 1.4 times the involute coefficient of the second groove portion 242. The involute coefficient of the fourth groove portion 244 is about 0.71 times the involute coefficient of the third groove portion 243.

A groove width of the first groove 221 decreases from upstream toward downstream. Specifically, a groove width of the second groove portion 242 is smaller than a groove width of the first groove portion 241, a groove width of the third groove portion 243 is smaller than the groove width of the second groove portion 242, and a groove width of the fourth groove portion 244 is smaller than the groove width of the third groove portion 243. Here, the groove width of each groove portion is a width in a direction orthogonal to the flow path direction. The groove width of the groove portion means a maximum value of the groove width of the groove portion. In the groove portion, it is preferable that the groove width continuously decreases from upstream toward downstream. The groove width of the groove portion may be an average value or a median value of the groove width of the groove portion.

A depth of the first groove 221 decreases from upstream toward downstream. In other words, a depth of the first groove 221 is a height of the outer wall and the inner wall defining the first groove 221. Specifically, a depth of the second groove portion 242 is smaller than a depth of the first groove portion 241, a depth of the third groove portion 243 is smaller than the depth of the second groove portion 242, and a depth of the fourth groove portion 244 is smaller than the depth of the third groove portion 243. Here, the depth of the groove portion means a maximum value of the depth of the groove portion. In the groove portion, it is preferable that the depth of the groove portion continuously decreases from upstream toward downstream. The depth of the groove portion may be an average value or a median value of the depth of the groove portion.

A thickness in the radial direction of the inner wall defining the first groove 221 varies depending on a position in the direction along the first groove 221. Here, the thickness in the radial direction of the inner wall means a maximum value of the thickness in the radial direction of the inner wall. As described above, the inner wall defining each groove portion of the first groove 221 is the second wall 235. A thickness in the radial direction of the inner wall defining the first groove portion 241 is different from a thickness in the radial direction of the inner wall defining the second groove portion 242. In the embodiment, a thickness T2 in the radial direction of the inner wall defining the second groove portion 242 is larger than a thickness T1 in the radial direction of the inner wall defining the first groove portion 241. The thickness in the radial direction of the inner wall defining the second groove portion 242 is different from a thickness in the radial direction of the inner wall defining the third groove portion 243. In the embodiment, a thickness T3 in the radial direction of the inner wall defining the third groove portion 243 is smaller than the thickness T2 in the radial direction of the inner wall defining the second groove portion 242. The thickness in the radial direction of the inner wall defining the third groove portion 243 is different from a thickness in the radial direction of the inner wall defining the fourth groove portion 244. In the embodiment, a thickness T4 in the radial direction of the inner wall defining the fourth groove portion 244 is smaller than the thickness T3 in the radial direction of the inner wall defining the third groove portion 243. The thickness in the radial direction of the inner wall may be an average value or a median value of the thickness in the radial direction of the inner wall.

The shape of the second groove 222 is the same as the shape of the first groove 221. Therefore, the description of the second groove 222 will be omitted.

According to the first embodiment described above, the groove 220 formed at the groove forming surface 210 of the flat screw 200 has a shape based on the involute curve from the central portion 201 toward the peripheral edge portion 202, and includes the first groove portion 241 and the second groove portion 242 located closer to the central portion 201 than the first groove portion 241 in the direction along the groove 220. The involute coefficient of the second groove portion 242 is smaller than the involute coefficient of the first groove portion 241, and the groove width of the second groove portion 242 is smaller than the groove width of the first groove portion 241. That is, the groove width downstream of the groove 220 is smaller than the groove width upstream of the groove 220.

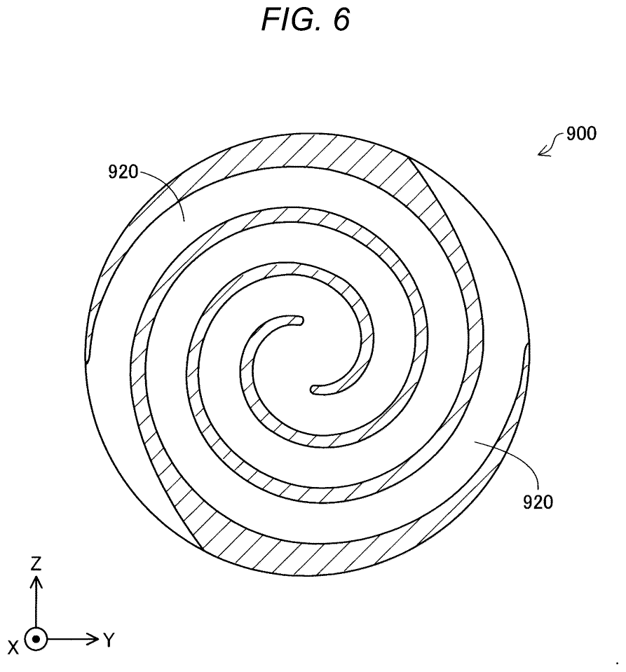

FIG. 6 is a diagram showing an example of a flat screw 900 having a groove 920 having a shape based on an involute curve with a constant involute coefficient. A groove width of the groove 920 of the flat screw 900 shown in FIG. 6 is constant regardless of a direction along the groove 920. In the flat screw 200 according to the embodiment, since the involute coefficient changes in the direction along the groove 220, the groove width of the groove 220 in the direction along the groove 220 can be changed. The flat screw 200 according to the embodiment has a larger upstream groove width than the flat screw 900 shown in FIG. 6. Therefore, an amount of the material that can flow into the groove 220 of the flat screw 200 according to the embodiment per unit time is larger than an amount of the material that can flow into the groove 920 of the flat screw 900 shown in FIG. 6 per unit time. That is, a plasticization amount per unit time in the flat screw 200 according to the embodiment is larger than a plasticization amount per unit time in the flat screw 900 shown in FIG. 6. Therefore, in the embodiment, it is possible to increase the plasticization amount while reducing an increase in size of the flat screw 200. The flat screw 200 according to the embodiment has a smaller downstream groove width than the flat screw 900 shown in FIG. 6. By reducing the groove width downstream, the material is compressed downstream, melting of the material is promoted, and pressure of the material in the downstream groove 220 increases. Accordingly, a pressure gradient between the upstream side and the downstream side increases. Therefore, in the embodiment, the plasticization amount can be increased as compared with that of the flat screw 900 having a constant groove width.

In the embodiment, the involute coefficient of the second groove portion 242 is smaller than the involute coefficient of the first groove portion 241. Therefore, even when the upstream groove width is increased, the thicknesses of the outer wall and the inner wall defining the groove 220 can be ensured.

In the embodiment, the thickness in the radial direction of the inner wall defining the first groove portion 241 is different from the thickness in the radial direction of the inner wall defining the second groove portion 242. Therefore, strength of a part of the inner wall can be improved.

In the embodiment, the thickness in the radial direction of the inner wall defining the second groove portion 242 is larger than the thickness in the radial direction of the inner wall defining the first groove portion 241. Therefore, strength of a portion of the inner wall defining the second groove portion 242 can be improved.

In the embodiment, the groove 220 includes the third groove portion 243 located closer to the central portion 201 than the second groove portion 242 in the direction along the groove 220, and the involute coefficient of the third groove portion 243 is larger than the involute coefficient of the second groove portion 242. Therefore, it is possible to increase the plasticization amount while reducing an increase in size of the flat screw 200. Even when the upstream groove width is increased, the thicknesses of the outer wall and the inner wall defining the groove 220 can be ensured.

In the embodiment, the thickness in the radial direction of the inner wall defining the second groove portion 242 is larger than the thickness in the radial direction of the inner wall defining the first groove portion 241, and is larger than the thickness in the radial direction of the inner wall defining the third groove portion 243. Therefore, strength of a portion of the inner wall defining the second groove portion 242 can be improved.

In the embodiment, the depth of the second groove portion 242 is smaller than the depth of the first groove portion 241. By reducing the depth of the groove 220 downstream, the material is compressed downstream, melting of the material is promoted, and pressure of the material in the downstream groove 220 increases. Accordingly, a pressure gradient between the upstream side and the downstream side increases. Therefore, in the embodiment, the plasticization amount can be increased as compared with that of the flat screw 200 in which the depth of the second groove portion 242 is equal to or greater than the depth of the first groove portion 241.

In the embodiment, the first groove 221 and the second groove 222, which are the grooves 220, are formed at the groove forming surface 210, and the first groove 221 and the second groove 222 have the same shape. Therefore, even in the flat screw 200 in which the plurality of grooves 220 are formed, it is possible to increase the plasticization amount while reducing an increase in size of the flat screw 200. Since the plurality of grooves 220 are formed, the plasticization amount can be increased as compared with that of the flat screw 200 in which one groove 220 is formed.

In the embodiment, the groove 220 is defined by the outer wall, the inner wall, and the bottom surface 239 between the outer wall and the inner wall, and includes the first groove portion 241 and the second groove portion 242 located closer to the central portion 201 than the first groove portion 241 in the direction along the groove 220. The thickness in the radial direction of the inner wall defining the first groove portion 241 is different from the thickness in the radial direction of the inner wall defining the second groove portion 242, and the groove width of the second groove portion 242 is smaller than the groove width of the first groove portion 241. In the embodiment, since the groove width of the first groove portion 241 is larger than the groove width of the second groove portion 242, an amount of material that can flow into the groove 220 per unit time can be increased. Therefore, it is possible to increase the plasticization amount while reducing an increase in size of the flat screw 200. In the embodiment, since the groove width of the second groove portion 242 is smaller than the groove width of the first groove portion 241, the material is compressed downstream, melting of the material is promoted, and pressure of the material in the downstream groove 220 increases. Accordingly, a pressure gradient between the upstream side and the downstream side increases. Therefore, the plasticization amount can be increased.

### B. Second Embodiment

In the second embodiment, shapes of a groove forming surface 210b and an opening 250b of a flat screw 200b are different from those of the first embodiment. A configuration of parts of the injection molding device 10 other than the flat screw 200b is the same as that of the first embodiment.

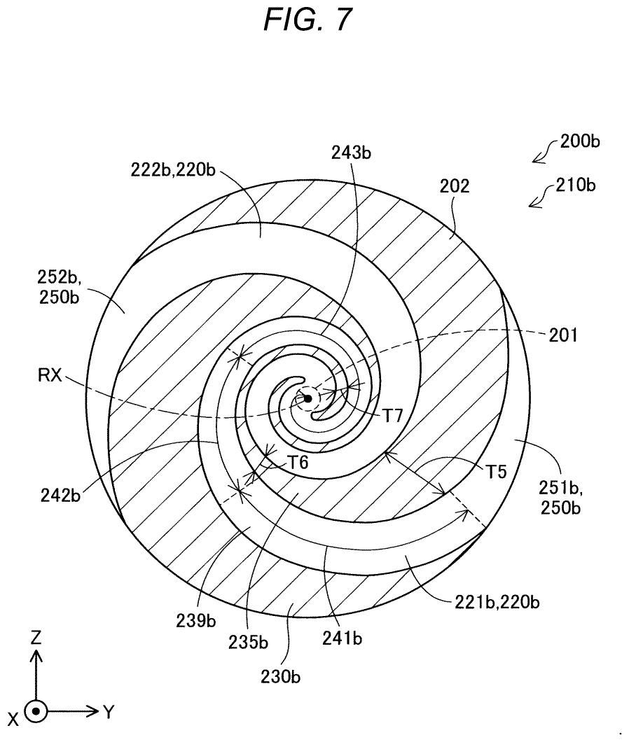

FIG. 7 is a plan view of a groove forming surface 210b side of the flat screw 200b in the second embodiment. A shape of the groove forming surface 210b when viewed from the direction along the central axis RX is a circular shape centered on the central axis RX. A first groove 221b and a second groove 222b, which are grooves 220b, are formed at the groove forming surface 210b. Shapes of the first groove 221b and the second groove 222b are based on an involute curve from the central portion 201 of the groove forming surface 210b toward the peripheral edge portion 202 of the groove forming surface 210b. A start point of the involute curve described above is a point on the central axis RX. The first groove 221b and the second groove 222b have the same shape and are rotationally symmetric about the central axis RX.

The groove forming surface 210b has a first wall 230b and a second wall 235b. The first wall 230b and the second wall 235b are portions of the groove forming surface 210b protruding toward the facing surface 133 of the barrel 130. The first wall 230b and the second wall 235b constitute side walls of the first groove 221b and the second groove 222b. Shapes of the first wall 230b and the second wall 235b are spiral shapes around the central portion 201. The first wall 230b and the second wall 235b have the same shape and are rotationally symmetric about the central axis RX. In FIG. 7, the first wall 230b and the second wall 235b are hatched to clearly show positions of the first wall 230b and the second wall 235b.

The groove 220b is defined by an outer wall, an inner wall, and a bottom surface 239b between the outer wall and the inner wall. The first groove 221b is defined with the first wall 230b as the outer wall and the second wall 235b as the inner wall. The second groove 222b is defined with the second wall 235b as the outer wall and the first wall 230b as the inner wall.

The flat screw 200b has a first opening 251b and a second opening 252b which are the openings 250b. The first opening 251b and the second opening 252b have the same shape and are rotationally symmetric about the central axis RX. The first groove 221b communicates with the first opening 251b. The second groove 222b communicates with the second opening 252b.

The first groove 221b includes a first groove portion 241b, a second groove portion 242b, and a third groove portion 243b. The first groove portion 241b communicates with the opening 250b. The second groove portion 242b communicates with the first groove portion 241b and is located closer to the central portion 201 than the first groove portion 241b in a direction along the first groove 221b. The third groove portion 243b communicates with the second groove portion 242b and is located closer to the central portion 201 than the second groove portion 242b in the direction along the first groove 221b. That is, the first groove portion 241b is located downstream of the opening 250b, the second groove portion 242b is located downstream of the first groove portion 241b, and the third groove portion 243b is located downstream of the second groove portion 242b. In FIG. 7, a range of each groove portion is indicated by an arrow.

An involute coefficient of the involute curve defining the shape of the first groove 221b changes in the direction along the first groove 221b. In the second embodiment, an involute coefficient of the second groove portion 242b is smaller than an involute coefficient of the first groove portion 241b. An involute coefficient of the third groove portion 243b is smaller than the involute coefficient of the second groove portion 242b. In the example shown in FIG. 7, the involute coefficient of the second groove portion 242b is about 0.84 times the involute coefficient of the first groove portion 241b. The involute coefficient of the third groove portion 243b is about 0.78 times the involute coefficient of the second groove portion 242b.

A groove width of the first groove 221b decreases from upstream toward downstream. Specifically, a groove width of the second groove portion 242b is smaller than a groove width of the first groove portion 241b, and a groove width of the third groove portion 243b is smaller than the groove width of the second groove portion 242b. In the groove portion, it is preferable that the groove width continuously decreases from upstream toward downstream.

A depth of the first groove 221b decreases from upstream toward downstream. Specifically, a depth of the second groove portion 242b is smaller than a depth of the first groove portion 241b, and a depth of the third groove portion 243b is smaller than the depth of the second groove portion 242b. In the groove portion, it is preferable that the depth of the groove portion continuously decreases from upstream toward downstream.

A thickness in the radial direction of the inner wall defining the first groove 221b varies depending on a position in the direction along the first groove 221b. As described above, the inner wall defining each groove portion of the first groove 221b is the second wall 235b. A thickness in the radial direction of the inner wall defining the first groove portion 241b is different from a thickness in the radial direction of the inner wall defining the second groove portion 242b. In the embodiment, a thickness T5 in the radial direction of the inner wall defining the first groove portion 241b is larger than a thickness T6 in the radial direction of the inner wall defining the second groove portion 242b. The thickness in the radial direction of the inner wall defining the second groove portion 242b is different from a thickness in the radial direction of the inner wall defining the third groove portion 243b. In the embodiment, a thickness T7 in the radial direction of the inner wall defining the third groove portion 243b is smaller than the thickness T6 in the radial direction of the inner wall defining the second groove portion 242b.

The shape of the second groove 222b is the same as the shape of the first groove 221b. Therefore, the description of the second groove 222b will be omitted.

According to the second embodiment described above, the groove 220b formed at the groove forming surface 210b of the flat screw 200b has a shape based on the involute curve from the central portion 201 toward the peripheral edge portion 202, and includes the first groove portion 241b and the second groove portion 242b located closer to the central portion 201 than the first groove portion 241b in a direction along the groove 220b. The involute coefficient of the second groove portion 242b is smaller than the involute coefficient of the first groove portion 241b, and the groove width of the second groove portion 242b is smaller than the groove width of the first groove portion 241b. Therefore, similarly to the first embodiment, it is possible to increase a plasticization amount while reducing an increase in size of the flat screw 200b. The plasticization amount can be increased as compared with that of the flat screw 900 having a constant groove width.

In the embodiment, the thickness in the radial direction of the inner wall defining the first groove portion 241b is larger than the thickness in the radial direction of the inner wall defining the second groove portion 242b. Therefore, strength of a portion of the inner wall defining the first groove portion 241b can be improved.

### C. Third Embodiment

In the third embodiment, shapes of a groove forming surface 210c and an opening 250c of a flat screw 200c are different from those of the first embodiment. A configuration of parts of the injection molding device 10 other than the flat screw 200c is the same as that of the first embodiment.

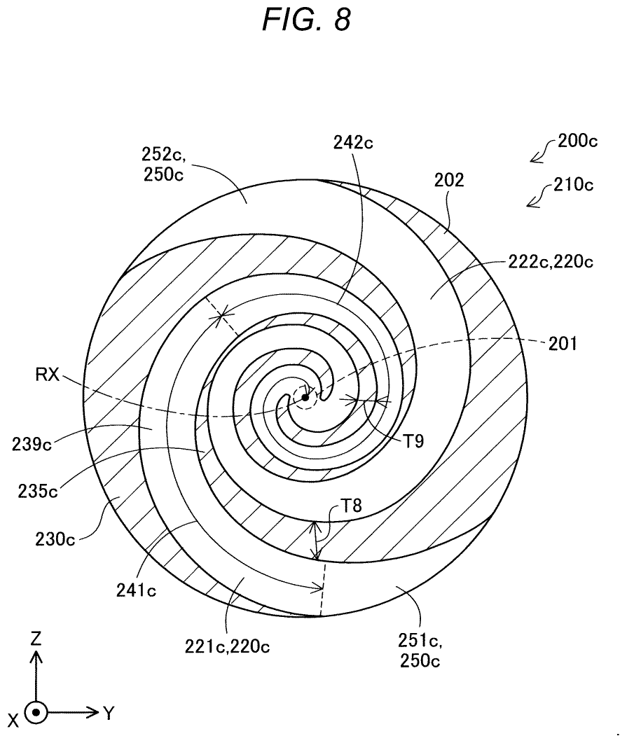

FIG. 8 is a plan view of a groove forming surface 210c side of the flat screw 200c in the third embodiment. A shape of the groove forming surface 210c when viewed from the direction along the central axis RX is a circular shape centered on the central axis RX. A first groove 221c and a second groove 222c, which are grooves 220c, are formed at the groove forming surface 210c. Shapes of the first groove 221c and the second groove 222c are based on an involute curve from the central portion 201 of the groove forming surface 210c toward the peripheral edge portion 202 of the groove forming surface 210c. A start point of the involute curve described above is a point on the central axis RX. The first groove 221c and the second groove 222c have the same shape and are rotationally symmetric about the central axis RX.

The groove forming surface 210c has a first wall 230c and a second wall 235c. The first wall 230c and the second wall 235c are portions of the groove forming surface 210c protruding toward the facing surface 133 of the barrel 130. The first wall 230c and the second wall 235c constitute side walls of the first groove 221c and the second groove 222c. Shapes of the first wall 230c and the second wall 235c are spiral shapes around the central portion 201. The first wall 230c and the second wall 235c have the same shape and are rotationally symmetric about the central axis RX. In FIG. 8, the first wall 230c and the second wall 235c are hatched to clearly show positions of the first wall 230c and the second wall 235c.

The groove 220c is defined by an outer wall, an inner wall, and a bottom surface 239c between the outer wall and the inner wall. The first groove 221c is defined with the first wall 230c as the outer wall and the second wall 235c as the inner wall. The second groove 222c is defined with the second wall 235c as the outer wall and the first wall 230c as the inner wall.

The flat screw 200c has a first opening 251c and a second opening 252c which are the openings 250c. The first opening 251c and the second opening 252c have the same shape and are rotationally symmetric about the central axis RX. The first groove 221c communicates with the first opening 251c. The second groove 222c communicates with the second opening 252c.

The first groove 221c includes a first groove portion 241c and a second groove portion 242c. The first groove portion 241c communicates with the opening 250c. The second groove portion 242c communicates with the first groove portion 241c and is located closer to the central portion 201 than the first groove portion 241c in a direction along the first groove 221c. That is, the first groove portion 241c is located downstream of the opening 250c, and the second groove portion 242c is located downstream of the first groove portion 241c. In FIG. 8, a range of each groove portion is indicated by an arrow.

An involute coefficient of the involute curve defining the shape of the first groove 221c changes in the direction along the first groove 221c. An involute coefficient of the second groove portion 242c is smaller than an involute coefficient of the first groove portion 241c. In the example shown in FIG. 8, the involute coefficient of the second groove portion 242c is about 0.84 times the involute coefficient of the first groove portion 241c.

A groove width of the first groove 221c decreases from upstream toward downstream. Specifically, a groove width of the second groove portion 242c is smaller than a groove width of the first groove portion 241c. In the groove portion, it is preferable that the groove width continuously decreases from upstream toward downstream.

A depth of the first groove 221c decreases from upstream toward downstream. Specifically, a depth of the second groove portion 242c is smaller than a depth of the first groove portion 241c. In the groove portion, it is preferable that the depth of the groove portion continuously decreases from upstream toward downstream.

A thickness in the radial direction of the inner wall defining the first groove 221c varies depending on a position in the direction along the first groove 221c. As described above, the inner wall defining each groove portion of the first groove 221c is the second wall 235c. A thickness in the radial direction of the inner wall defining the first groove portion 241c is different from a thickness in the radial direction of the inner wall defining the second groove portion 242c. In the embodiment, a thickness T8 in the radial direction of the inner wall defining the first groove portion 241c is larger than a thickness T9 in the radial direction of the inner wall defining the second groove portion 242c.

The shape of the second groove 222c is the same as the shape of the first groove 221c. Therefore, the description of the second groove 222c will be omitted.

According to the third embodiment described above, the groove 220c formed at the groove forming surface 210c of the flat screw 200c has a shape based on the involute curve from the central portion 201 toward the peripheral edge portion 202, and includes the first groove portion 241c and the second groove portion 242c located closer to the central portion 201 than the first groove portion 241c in the direction along the groove 220c. The involute coefficient of the second groove portion 242c is smaller than the involute coefficient of the first groove portion 241c, and the groove width of the second groove portion 242c is smaller than the groove width of the first groove portion 241c. Therefore, similarly to the first embodiment, it is possible to increase a plasticization amount while reducing an increase in size of the flat screw 200c. The plasticization amount can be increased as compared with that of the flat screw 900 having a constant groove width.

In the embodiment, the thickness in the radial direction of the inner wall defining the first groove portion 241c is larger than the thickness in the radial direction of the inner wall defining the second groove portion 242c. Therefore, strength of a portion of the inner wall defining the first groove portion 241c can be improved.

### D. Other Embodiments

(D-1) In the first embodiment, the involute coefficient of the second groove portion 242 is smaller than the involute coefficient of the first groove portion 241, the involute coefficient of the third groove portion 243 is larger than the involute coefficient of the second groove portion 242, and the involute coefficient of the fourth groove portion 244 is smaller than the involute coefficient of the third groove portion 243. In contrast, the involute coefficient of the second groove portion 242 may be smaller than the involute coefficient of the first groove portion 241, the involute coefficient of the third groove portion 243 may be smaller than the involute coefficient of the second groove portion 242, and the involute coefficient of the fourth groove portion 244 may be smaller than the involute coefficient of the third groove portion 243. The involute coefficient of the second groove portion 242 may be smaller than the involute coefficient of the first groove portion 241, the involute coefficient of the third groove portion 243 may be smaller than the involute coefficient of the second groove portion 242, and the involute coefficient of the fourth groove portion 244 may be larger than the involute coefficient of the third groove portion 243. The involute coefficient of the second groove portion 242 may be smaller than the involute coefficient of the first groove portion 241, the involute coefficient of the third groove portion 243 may be larger than the involute coefficient of the second groove portion 242, and the involute coefficient of the fourth groove portion 244 may be larger than the involute coefficient of the third groove portion 243.

(D-2) In the second embodiment, the involute coefficient of the second groove portion 242b is smaller than the involute coefficient of the first groove portion 241b, and the involute coefficient of the third groove portion 243b is smaller than the involute coefficient of the second groove portion 242b. In contrast, the involute coefficient of the second groove portion 242b may be smaller than the involute coefficient of the first groove portion 241b, and the involute coefficient of the third groove portion 243b may be larger than the involute coefficient of the second groove portion 242b.

(D-3) In the first embodiment, the involute coefficient of the involute curve defining the shape of the groove 220 changes in four stages in the direction along the groove 220. In the second embodiment, the involute coefficient of the involute curve defining the shape of the groove 220b changes in three stages in the direction along the groove 220b. In the third embodiment, the involute coefficient of the involute curve defining the shape of the groove 220c changes in two stages in the direction along the groove 220c. In contrast, the involute coefficient of the involute curve defining the shape of the groove 220 may change in five or more stages in the direction along the groove 220.

(D-4) In the first embodiment, the depth of the second groove portion 242 is smaller than the depth of the first groove portion 241, the depth of the third groove portion 243 is smaller than the depth of the second groove portion 242, and the depth of the fourth groove portion 244 is smaller than the depth of the third groove portion 243. In contrast, the depth of the second groove portion 242 may be equal to or greater than the depth of the first groove portion 241. The depth of the third groove portion 243 may be equal to or greater than the depth of the second groove portion 242. The depth of the fourth groove portion 244 may be equal to or greater than the depth of the third groove portion 243.

(D-5) In the second embodiment, the depth of the second groove portion 242b is smaller than the depth of the first groove portion 241b, and the depth of the third groove portion 243b is smaller than the depth of the second groove portion 242b. In contrast, the depth of the second groove portion 242b may be equal to or greater than the depth of the first groove portion 241b. The depth of the third groove portion 243b may be equal to or greater than the depth of the second groove portion 242b.

(D-6) In the third embodiment, the depth of the second groove portion 242c is smaller than the depth of the first groove portion 241c. In contrast, the depth of the second groove portion 242c may be equal to or greater than the depth of the first groove portion 241c.

(D-7) In the first embodiment, the thickness T4 in the radial direction of the inner wall defining the fourth groove portion 244 is smaller than the thickness T3 in the radial direction of the inner wall defining the third groove portion 243. In contrast, the thickness T4 in the radial direction of the inner wall defining the fourth groove portion 244 may be equal to or larger than the thickness T3 in the radial direction of the inner wall defining the third groove portion 243.

(D-8) In the embodiment described above, the two grooves 220 are formed at the groove forming surface 210. In contrast, one groove 220 or three or more grooves 220 may be formed at the groove forming surface 210.

(D-9) The above disclosure may be achieved in the form of a three-dimensional modeling device including the plasticizing unit 20 and a stage on which the material plasticized by the plasticizing unit 20 is stacked.

### E. Other Aspects

The present disclosure is not limited to the embodiments described above, and can be implemented in various forms without departing from the scope of the present disclosure. For example, the present disclosure may also be implemented in the following configurations. The technical features in the embodiments described above corresponding to the technical features in the configurations described below can be replaced or combined as appropriate in order to solve a part or all of the problems of the present disclosure, or to achieve a part or all of the effects of the present disclosure. Further, any of the technical features can be eliminated as appropriate unless described as essential in the present specification.

(1) According to a first aspect of the present disclosure, a plasticizing device for plasticizing a material is provided. The plasticizing device includes: a drive motor; a screw having a groove forming surface at which a groove is formed, the screw being rotated by the drive motor; and a barrel facing the groove forming surface and having a communication hole at a position facing a central portion of the groove forming surface, in which the groove has a shape based on an involute curve from the central portion toward a peripheral edge portion of the groove forming surface, the groove is defined by an outer wall, an inner wall having a distance from the central portion in a radial direction shorter than a distance of the outer wall from the central portion, and a bottom surface between the outer wall and the inner wall, the groove includes a first groove portion, and a second groove portion located closer to the central portion than the first groove portion in a direction along the groove, an involute coefficient of the second groove portion is smaller than an involute coefficient of the first groove portion, and a groove width of the second groove portion is smaller than a groove width of the first groove portion.

According to such an aspect, an amount of the material that can flow into the groove of the screw per unit time can be made larger than that of a screw having a constant groove width regardless of a direction along the groove. That is, a plasticization amount per unit time can be made larger than that of the screw having a constant groove width regardless of the direction along the groove. Therefore, it is possible to increase the plasticization amount while reducing an increase in size of the screw. Since the groove width of the second groove portion is smaller than the groove width of the first groove portion, the material is compressed in the second groove portion, melting of the material is promoted, pressure of the material in the second groove portion increases, and a pressure gradient between the first groove portion and the second groove portion increases. Therefore, the plasticization amount can be increased as compared with that of a screw in which the groove width of the second groove portion is equal to or larger than the groove width of the first groove portion.

(2) In the above aspect, a thickness in the radial direction of the inner wall defining the first groove portion may be different from a thickness in the radial direction of the inner wall defining the second groove portion.

According to such an aspect, strength of a part of the inner wall can be improved.

(3) In the above aspect, the thickness in the radial direction of the inner wall defining the second groove portion may be larger than the thickness in the radial direction of the inner wall defining the first groove portion.

According to such an aspect, strength of a portion of the inner wall defining the second groove portion can be improved.

(4) In the above aspect, the thickness in the radial direction of the inner wall defining the first groove portion may be larger than the thickness in the radial direction of the inner wall defining the second groove portion.

According to such an aspect, strength of a portion of the inner wall defining the first groove portion can be improved.

(5) In the above aspect, the groove may include a third groove portion located closer to the central portion than the second groove portion in the direction along the groove, and an involute coefficient of the third groove portion may be larger than the involute coefficient of the second groove portion.

According to such an aspect, it is possible to increase the plasticization amount while reducing an increase in size of the screw.

(6) In the above aspect, a thickness in the radial direction of the inner wall defining the second groove portion may be larger than a thickness in the radial direction of the inner wall defining the first groove portion, and may be larger than a thickness in the radial direction of the inner wall defining the third groove portion.

According to such an aspect, strength of a portion of the inner wall defining the second groove portion can be improved.

(7) In the above aspect, a depth of the second groove portion may be smaller than a depth of the first groove portion.

According to such an aspect, the material is compressed in the second groove portion, melting of the material is promoted, pressure of the material of the second groove portion increases, and a pressure gradient between the first groove portion and the second groove portion increases. Therefore, the plasticization amount can be increased as compared with that of the screw in which the depth of the second groove portion is equal to or greater than the depth of the first groove portion.

(8) In the above aspect, a plurality of grooves including a first groove and a second groove which are the grooves may be formed at the groove forming surface, and the first groove and the second groove may have the same shape.

According to such an aspect, even in the screw in which the plurality of grooves are formed, it is possible to increase the plasticization amount while reducing an increase in size of the screw. Since the plurality of grooves are formed, the plasticization amount can be increased as compared with that of the screw in which one groove is formed.

(9) According to a second aspect of the present disclosure, an injection molding device is provided. The injection molding device includes the plasticizing device according to the first aspect, and a mold opening and closing device configured to open and close a mold having a cavity to which the material plasticized by the plasticizing device is to be supplied.

According to such an aspect, it is possible to increase a plasticization amount while reducing an increase in size of the screw in the injection molding device.

(10) According to a third aspect of the present disclosure, a screw to be mounted on a plasticizing device is provided. The screw includes: a groove forming surface at which a groove is formed, in which the groove has a shape based on an involute curve from a central portion of the groove forming surface toward a peripheral edge portion of the groove forming surface, the groove is defined by an outer wall, an inner wall having a distance from the central portion in a radial direction shorter than a distance of the outer wall from the central portion, and a bottom surface between the outer wall and the inner wall, the groove includes a first groove portion, and a second groove portion located closer to the central portion than the first groove portion in a direction along the groove, an involute coefficient of the second groove portion is smaller than an involute coefficient of the first groove portion, and a groove width of the second groove portion is smaller than a groove width of the first groove portion.

According to such an aspect, an amount of the material that can flow into the groove of the screw per unit time can be made larger than that of a screw having a constant groove width regardless of a direction along the groove. That is, a plasticization amount per unit time can be made larger than that of the screw having a constant groove width regardless of the direction along the groove. Therefore, it is possible to increase the plasticization amount while reducing an increase in size of the screw. Since the groove width of the second groove portion is smaller than the groove width of the first groove portion, the material is compressed in the second groove portion, melting of the material is promoted, pressure of the material in the second groove portion increases, and a pressure gradient between the first groove portion and the second groove portion increases. Therefore, the plasticization amount can be increased as compared with that of a screw in which the groove width of the second groove portion is equal to or larger than the groove width of the first groove portion.

(11) According to a third aspect of the present disclosure, a screw to be mounted on a plasticizing device is provided. The screw includes: a groove forming surface at which a spiral groove is formed, in which the groove is defined by an outer wall, an inner wall having a distance from a central portion of the groove forming surface in a radial direction shorter than a distance of the outer wall from the central portion, and a bottom surface between the outer wall and the inner wall, the groove includes a first groove portion, and a second groove portion located closer to the central portion than the first groove portion in a direction along the groove, a thickness in the radial direction of the inner wall defining the first groove portion is different from a thickness in the radial direction of the inner wall defining the second groove portion, and a groove width of the second groove portion is smaller than a groove width of the first groove portion.

According to such an aspect, an amount of the material that can flow into the groove of the screw per unit time can be made larger than that of a screw having a constant groove width regardless of a direction along the groove. That is, a plasticization amount per unit time can be made larger than that of the screw having a constant groove width regardless of the direction along the groove. Therefore, it is possible to increase the plasticization amount while reducing an increase in size of the screw. Since the groove width of the second groove portion is smaller than the groove width of the first groove portion, the material is compressed in the second groove portion, melting of the material is promoted, pressure of the material in the second groove portion increases, and a pressure gradient between the first groove portion and the second groove portion increases. Therefore, the plasticization amount can be increased as compared with that of a screw in which the groove width of the second groove portion is equal to or larger than the groove width of the first groove portion.

What is claimed is:

1. A plasticizing device for plasticizing a material, the plasticizing device comprising:
a drive motor;
a screw having a groove forming surface at which a groove is formed, the screw being rotated by the drive motor; and
a barrel facing the groove forming surface and having a communication hole at a position facing a central portion of the groove forming surface, wherein
the groove has a shape based on an involute curve from the central portion toward a peripheral edge portion of the groove forming surface,
the groove is defined by an outer wall, an inner wall having a distance from the central portion in a radial direction shorter than a distance of the outer wall from the central portion, and a bottom surface between the outer wall and the inner wall,
the groove includes
a first groove portion, and
a second groove portion located closer to the central portion than the first groove portion in a direction along the groove,
an involute coefficient of the second groove portion is smaller than an involute coefficient of the first groove portion, and
a groove width of the second groove portion is smaller than a groove width of the first groove portion.

2. The plasticizing device according to claim 1, wherein
a thickness in the radial direction of the inner wall defining the first groove portion is different from a thickness in the radial direction of the inner wall defining the second groove portion.

3. The plasticizing device according to claim 2, wherein
the thickness in the radial direction of the inner wall defining the second groove portion is larger than the thickness in the radial direction of the inner wall defining the first groove portion.

4. The plasticizing device according to claim 2, wherein
the thickness in the radial direction of the inner wall defining the first groove portion is larger than the thickness in the radial direction of the inner wall defining the second groove portion.

5. The plasticizing device according to claim 1, wherein
the groove includes a third groove portion located closer to the central portion than the second groove portion in the direction along the groove, and
an involute coefficient of the third groove portion is larger than the involute coefficient of the second groove portion.

6. The plasticizing device according to claim 5, wherein
a thickness in the radial direction of the inner wall defining the second groove portion is larger than a thickness in the radial direction of the inner wall defining the first groove portion, and is larger than a thickness in the radial direction of the inner wall defining the third groove portion.

7. The plasticizing device according to claim 1, wherein
a depth of the second groove portion is smaller than a depth of the first groove portion.

8. The plasticizing device according to claim 1, wherein
a plurality of grooves including a first groove and a second groove which are the grooves are formed at the groove forming surface, and
the first groove and the second groove have the same shape.

9. An injection molding device comprising:
the plasticizing device according to claim 1; and
a mold opening and closing device configured to open and close a mold having a cavity to which the material plasticized by the plasticizing device is to be supplied.

10. A screw to be mounted on a plasticizing device, the screw comprising:
a groove forming surface at which a groove is formed, wherein
the groove has a shape based on an involute curve from a central portion of the groove forming surface toward a peripheral edge portion of the groove forming surface,
the groove is defined by an outer wall, an inner wall having a distance from the central portion in a radial direction shorter than a distance of the outer wall from the central portion, and a bottom surface between the outer wall and the inner wall,
the groove includes
a first groove portion, and
a second groove portion located closer to the central portion than the first groove portion in a direction along the groove,
an involute coefficient of the second groove portion is smaller than an involute coefficient of the first groove portion, and
a groove width of the second groove portion is smaller than a groove width of the first groove portion.

11. A screw to be mounted on a plasticizing device, the screw comprising:
a groove forming surface at which a spiral groove is formed, wherein
the groove is defined by an outer wall, an inner wall having a distance from a central portion of the groove forming surface in a radial direction shorter than a distance of the outer wall from the central portion, and a bottom surface between the outer wall and the inner wall,
the groove includes
a first groove portion, and
a second groove portion located closer to the central portion than the first groove portion in a direction along the groove,
a thickness in the radial direction of the inner wall defining the first groove portion is different from a thickness in the radial direction of the inner wall defining the second groove portion, and
a groove width of the second groove portion is smaller than a groove width of the first groove portion.
